(19) United States
(12) Patent Application Publication
(10) Pub. No.: US 2022/0012704 A1
(43) Pub. Date: Jan. 13, 2022

(54) PERIODIC TO REAL TIME CRYPTOCURRENCY-BASED WORK PAYMENT METHOD

(71) Applicant: Haramol Singh Sandhu, McLean, VA (US)

(72) Inventor: Haramol Singh Sandhu, McLean, VA (US)

(21) Appl. No.: 16/922,879

(22) Filed: Jul. 7, 2020

(51) Int. Cl. G06Q 20/12; G06Q 20/06; G06Q 30/08; G06Q 50/18; G06Q 20/36; G06Q 10/10; G06Q 20/08; G06F 9/455

(52) U.S. Cl. CPC G06Q 20/127; G06Q 20/0655; G06Q 30/08; G06Q 50/188; G06F 2009/45595; G06Q 10/1093; G06Q 20/085; G06F 9/45558; G06Q 2220/00; G06Q 20/3678

(57) ABSTRACT

In one embodiment, a computer-implemented method is described whereby cryptocurrency for services being rendered is transferred from an account or wallet of the service buyer to an account or wallet of the service provider at regular frequent intervals, such as daily, hourly, near real-time, or real-time as the service provider is working. In this embodiment, it is contemplated that data with respect to the amount transferred is readily accessible in real-time by both parties.

### CROSS REFERENCE TO RELATED APPLICATION

This application claims priority under 35 U.S.C. § 119(e) of U.S. Provisional Application 62/879,493, filed Jul. 28, 2019, the entire contents of which are hereby incorporated by reference.

### FIELD OF THE INVENTION

The present invention relates to the procurement of services. More specifically, the present invention relates to the payment of service providers by service buyers for work via cryptocurrency.

### BACKGROUND

Traditionally, for both jobs and gigs, payments for services from service buyers to service providers take place at certain times, such as bi-weekly or after completion of a gig, that do not closely align with the actual provision of services. These methods result in numerous inefficiencies in general and at least one party generally being disadvantaged. For example, for traditional jobs, service is generally performed with payment delayed for a period of time—often a couple of weeks or more. On the other hand, if payment is paid before service is performed, then the service provider gets the benefit of receiving the value for work performed without having done the work. In addition to other inefficiencies, these approaches may not properly incentivize satisfactory performance. Traditional banking systems and payroll systems and the cost to transfer money make it difficult to switch from these systems. These inefficiencies are often even more pronounced for gigs or other project based work than for jobs. For instance, these inefficiencies can often even prevent transactions between service providers and service buyers from even occurring at all, especially when the parties do not have an established relationship and lack trust with respect to payment. Systems such as escrow of payment, while they may offer some level of protection to the service provider, still result in immense inefficiencies that are often prohibitive, both in terms of added cost and also because receipt of payment is still delayed. In addition, due to the existing financial infrastructure and traditional payment methods for jobs and gigs, jobs and gigs may not be as easily accessible to service buyers and service providers who are unbanked or under-banked.

### REFERENCES CITED

### U.S. Patent Documents

| | | |
|---|---|---|
| U.S. 2007/0192130 | August 2007 | Sandhu |
| U.S. Pat. No. 8,380,709 B1 | February 2013 | Diller et. al. |
| U.S. Pat. No. 8,700,614 B1 | April 2014 | Diller et. al. |
| WO 2010018450 A2 | February 2010 | McCarney et. al. |
| U.S. 13/750,871 | August 2013 | Hindi et. al. |
| U.S. 2013/0246301 A1 | September 2013 | Radhakrishnan et. al. |
| U.S. 14/459,114 | February 2015 | Sandhu |
| U.S. 14/871946 | April 2016 | Sandhu |
| U.S. 20190034889 A1 | January 2019 | Brock et. al. |
| U.S. 20190139069A1 | May 2019 | Sandhu |

### SUMMARY

In one embodiment, the method includes transmitting the regular payment of cryptocurrency through a network from an account or wallet of the service buyer to an account or wallet of the service provider as time performing a job or gig elapses, with payment either at regular intervals to near real-time to real-time concurrently with the performance of services. In this embodiment, the method includes the use of a device to access and respond to job or gig information in real time, including potentially ending the remainder of the engagement or re-negotiating terms of future time blocks.

### BRIEF DESCRIPTION OF THE DRAWINGS

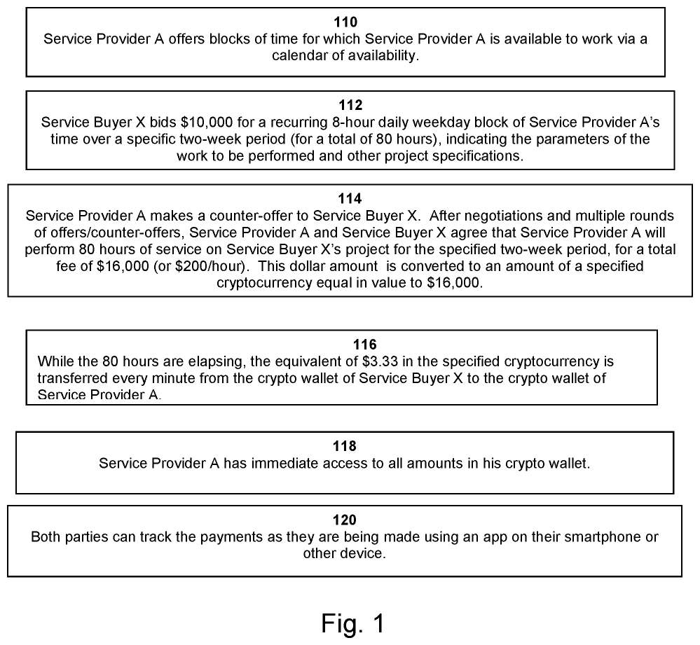

Non-limiting and non-exhaustive embodiments of the invention are described, in part, with reference to FIG. 1, which is an exemplary flow chart showing a portion of the steps taken with respect to a project/job using the system.

### DETAILED DESCRIPTION

This document describes a system and method for the payment of service providers by service buyers. In the following description, numerous specific details are set forth to provide a thorough understanding of the embodiments. One skilled in the relevant art will recognize, however, that the techniques described herein can be practiced without one or more of the specific details, or with other methods or details. In other instances, well-known operations are not shown or described in detail to avoid obscuring certain aspects.

Reference throughout this specification to “one embodiment” or similar terminology means that a particular feature, structure, or characteristic described in connection with the embodiment is included in at least one embodiment of the present invention. Thus, the appearance of the phrase “in one embodiment” or similar terminology in various places throughout this specification are not necessarily all referring to the same embodiment. Furthermore, particular features or characteristics described herein may be combined in any suitable manner in one or more embodiments.

In one embodiment, a service provider makes their calendar of time available on the marketplace platform, potentially restricting bidding on certain time blocks for which the service provider is already booked and/or is not willing to work 110.

In one embodiment, service buyers can bid for a service provider's time by setting out project details, specifying the dollar value of the bid (potentially with different hourly bids for different portions of the time block), and by specifying the block of time being bid upon (e.g., 9-11 AM on Sep. 3, 2020, or a recurring block over a period of days, weeks, or months). 112. It is also contemplated that the service providers could leave blocks of time open for a period to get competing bids, and can choose to accept, reject, or counter bids based on all information (e.g., project specifications, billing rate per hour worked, overall fee, any fee guarantees, total time allotted, etc.), and not just based on price. For example, the system could have a default that time blocks can be bid upon up until 24 hours in advance of the time block, and that bidders can bid on any open (either unreserved or not blocked off) time blocks of 15-minute or greater increments. Thus, for example, two different potential service buyers can bid on overlapping time blocks of the same professional such, as for example, one bid on a 11 AM-12 PM time block on a particular day, and a competing bid on a 11 AM-3 PM time block on that same day (potentially with, for example, a higher bid for the 11 AM-12 PM portion of the time block in order to outbid the competing bid on that portion of the time block) and the service provider can choose to accept one and/or counter with one or more to suggest a different non-overlapping time block. In addition, it is contemplated that the service provider could counter-offer at a higher rate, higher overall fee, with a change in project scope, and/or a different block of time (including a smaller or larger block of time or time on a different day, etc.) 114.

In some embodiments, in the case of a discrete time block, it is contemplated that, if the service provider and service buyer agree to a block of time, that block of the service provider's time would be reserved in the system and unavailable for bids. It is also contemplated that in some embodiments the system could use a methodology whereby a service buyer and service provider can agree to a small trial block of time with, for example, an option agreed to between the parties enabling the service buyer to be guaranteed the ability to purchase additional blocks of the service provider's time at a set price or future agreed upon price in order to continue to work on the project. Any unused portion of a block would become available for bidding for additional work by the same or other service buyers.

In the preferred embodiment, it is contemplated that fees for the block of time would be paid through the marketplace platform using cryptocurrency from an account of the service buyer to an account of the service provider as the time block or a portion of the time block is being worked. In some embodiments, this disbursement could occur every day, in some embodiments every hour, every minute or otherwise. 116. In the preferred embodiment, this transfer of value would be dripped out in real-time to near real-time. In some embodiments, the payment frequency could be negotiated or otherwise set.

In the preferred embodiment, the transfer of value would occur directly from an account of the service buyer to an account of the service provider using the marketplace platform. In other embodiments, the payment by the service buyer may be made to the marketplace platform using traditional fiat currency with disbursement to the service provider made using cryptocurrency.

In some embodiments, the accounts to which value is transferred may be accounts or sub-account on the marketplace platform. In other embodiments, the accounts could be accounts at other institutions or other third-party accounts. In other embodiments, the accounts may be private wallets or other accounts or storage mechanisms owned or controlled by the parties. 118

In the preferred embodiment, it is contemplated that both parties would have access to the real-time payment information and other engagement information using a device connected to the marketplace platform and/or connected directly to their accounts, whereby they can track the payments in real-time and access other information regarding the engagement. 120

In the preferred embodiment, it is contemplated that either the service buyer or service provider could immediately end the engagement by stopping the payments through a device used to access the marketplace platform. In some embodiments, this ability could be limited to certain set periods or otherwise or there could be a set or negotiated delay from the time a party indicates the desire to end the engagement to when payment stops. In some embodiments, there could be a certain amount of guaranteed payments.

In some embodiments, it is contemplated that re-negotiation as to terms of future time blocks including the price per unit of time worked could be done in near-real time or at certain intervals using a device. In some embodiments, this negotiating right could be a bilateral or unilateral option as to some or all terms.

In some embodiments, the methodology would include an auction system whereby the service provider offers up their blocks of time to be bid upon or otherwise purchased by potential service buyers using the marketplace platform.

As indicated above, FIG. 1 is provided merely as an example. Other examples are possible and may differ from what was described with regard to FIG. 1.

Device may include a user device with a communication and/or computing device, such as a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device. Further, a device may include a vehicle (autonomous or user-driven), a transaction terminal, and/or any other type of device capable of connecting to a network according to implementations described herein.

Cloud computing environment includes an environment that delivers computing as a service, whereby shared resources, services, and/or the like may be provided to devices. Cloud computing environment includes an environment that hosts marketplace platform. Cloud computing environment may provide computation, software, data access, storage, and/or other services that do not require end-user knowledge of a physical location and/or configuration of a system and/or a devices. As shown, cloud computing environment may include a group of computing resources (which may be referred to herein individually as computing resource).

While implementations described herein describe or contemplate marketplace platform as being hosted in cloud computing environment, in some implementations, marketplace platform may not be cloud-based (i.e., may be implemented outside of a cloud computing environment) or may be partially cloud-based.

Computing resource includes one or more personal computers, workstation computers, server devices, or another type of computation and/or communication device. In some implementations, one or more computing resources may host marketplace platform. The cloud resources may include compute instances executing in computing resource, storage devices provided in computing resource, data transfer devices provided by computing resource, etc. In some implementations, computing resource may communicate with other computing resources via wired connections, wireless connections, or a combination of wired and wireless connections.

Application includes one or more software applications that may be provided to or accessed by device. Application may eliminate a need to install and execute the software applications on device. For example, application may include software associated with marketplace platform and/or any other software capable of being provided via cloud computing environment. In some implementations, one application may send/receive information to/from one or more other applications, via virtual machine.

Virtual machine includes a software implementation of a machine (e.g., a computer) that executes programs like a physical machine. Virtual machine may be either a system virtual machine or a process virtual machine, depending upon use and degree of correspondence to any real machine by virtual machine. A system virtual machine may provide a complete system platform that supports execution of a complete operating system (“OS”). A process virtual machine may execute a single program, and may support a single process. In some implementations, virtual machine may execute on behalf of a user (e.g., via device), and may manage infrastructure of cloud computing environment, such as data management, synchronization, or long-duration data transfers.

In the preferred embodiment, it is contemplated that the marketplace platform is accessed by service buyers, service providers, and others using one or more devices connected to a network. Network includes one or more wired and/or wireless networks. For example, network may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks described herein are provided as an example. In practice, there may be additional devices and/or networks, fewer devices and/or networks, different devices and/or networks, or differently arranged devices and/or networks than those described. Furthermore, two or more devices may be implemented within a single device, or a single device may be implemented as multiple, distributed devices. Additionally, or alternatively, a set of devices (e.g., one or more devices) of environment may perform one or more functions described as being performed by another set of devices or computing resources of environment.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The present invention has been described in terms of specific embodiments incorporating details to facilitate the understanding of principles of construction and operation of the invention. The description herein is not intended to be exhaustive or to limit the invention to the precise forms disclosed. Variations to specific embodiments and details are encompassed by this disclosure. Thus, for example, even though service buyers and service providers are generally described as individuals herein, it is contemplated that each can instead be groups of individuals or entities. Similarly, even though the invention is generally described as applying to discrete projects herein, it is contemplated that this invention can also apply to longer-term jobs or other types of jobs. It is intended that the scope of the invention is defined by the claims and their equivalents. Furthermore, it is contemplated that a particular feature described either individually or as part of an embodiment, can be combined with other individually described features, or parts of other embodiments. Thus, absence of describing combinations should not preclude the inventor from claiming rights to such combinations. Various modifications to the disclosed embodiments will be readily apparent to those skilled in the art, and the general principles defined herein may be applied to other embodiments and applications without departing from the spirit and scope of the present embodiments. Thus, the system is not limited to the embodiments shown, but is to be accorded the widest scope consistent with the principles and features disclosed herein.

The invention claimed is:

1. A method for paying for services, comprising: purchasing services in units of a service provider's time; disbursing payments from accounts of service buyers to accounts of service providers using cryptocurrency; and for providing such payments automatically as time elapses, potentially as frequently as in real time as services are performed.

2. The method of claim 1, wherein the purchasing of units of time takes place via an auction marketplace whereby service buyers bid on or otherwise purchase service providers' available time.

3. The method of claim 1, further comprising the right of one or both parties to terminate future unworked time blocks of an engagement via a device.

4. The method of claim 1, further comprising the right of one or both parties to renegotiate terms for future unworked time blocks of an engagement via a device.

5. The method of claim 1, further comprising the right of one or both parties to have an option with respect to one or more terms for future unworked time blocks of an engagement, wherein such option can be exercised via a device.
